(19) United States
(12) Patent Application Publication
(10) Pub. No.: US 2020/0171688 A1
(43) Pub. Date: Jun. 4, 2020

(54) SAFETY RAZOR HANDLE

(71) Applicant: BEIERSDORF AG, Hamburg (DE)

(72) Inventors: Peter MAURER, Neumuenster (DE); Alexander KRUEMKE, Hamburg (DE); Michaela KOHUT, Hamburg (DE); Arne SCHULTCHEN, Hamburg (DE); Andre FELDMANN, Hamburg (DE); Christine JUNG, Hamburg (DE); Armin WARNECKE, Hamburg (DE)

(21) Appl. No.: 16/631,563

(22) PCT Filed: Jul. 16, 2018
(86) PCT No.: PCT/EP2018/069308

§ 371 Date: Jan. 16, 2020

(30) Foreign Application Priority Data
Jul. 17, 2017 (DE) 102017116063.9

(51) Int. Cl. B26B 21/52

(52) U.S. Cl. CPC B26B 21/522; B26B 21/521

(57) ABSTRACT

A safety razor handle comprising: an underneath surface portion facing the skin of the user in use and comprising an attachment means for attachment to a blade unit; a front surface portion facing in the opposite direction from the shaving direction in use; a rear surface portion facing in the shaving direction in use; a top surface portion and side surface portions, one directed to either side of the blade length in use; wherein the top surface portion, underneath surface portion and side surface portions together form a continuous smooth surface (which is a substantially cylindrical or substantially ellipsoid or substantially partially spherical surface; and wherein: the distance between the front surface portion and rear surface portion is between one third and three times, preferably between a half and twice, the largest dimension of the largest cross section through the continuous smooth surface.

### FIELD

Embodiments described herein relate to a handle for a safety razor.

### BACKGROUND

Safety razors are typically composed of a blade unit (or cartridge) connected, either detachably or fixedly (permanently fixed or integrated), to a handle. A safety razor with a detachable and disposable blade unit is known as a safety razor system. Blade units are known which have one or more parallel blades perpendicular to the shaving direction and thus to the handle, each defining a cutting edge, with blade unit elements positioned in front of and behind (rear of) the cutting edge(s) (referred to as a “guard” and a “cap”, respectively) in a shaving direction. A shaving aid, such as a thin lubricating strip, is often incorporated into one or both of these blade unit elements to improve shaving performance and lubricating treatment of the user's skin. Typically, the handle is elongate extending essentially in the direction of shaving. It would be desirable to provide alternative handle design.

### BRIEF SUMMARY

Embodiments of the invention provide a safety razor handle comprising: an underneath surface portion facing the skin of the user in use and comprising an attachment means for attachment to a blade unit; a front surface portion facing in the opposite direction from the shaving direction in use; a rear surface portion facing in the shaving direction in use; a top surface portion and side surface portions, one directed to either side of the blade length in use; wherein the top surface portion, underneath surface portion and side surface portions together form a continuous smooth surface which is a substantially cylindrical or substantially ellipsoid or substantially partially spherical surface; and wherein: the distance between the front surface portion and rear surface portion is between one third and three times, preferably between a half and twice, the largest dimension of the largest cross section through the continuous smooth surface.

The “chunky” bulbous shapes of the handle allow a particularly flexible ergonomic handling, giving many varied gripping positions for the human hand and easy twisting of the handle within the grip to reach different angles. Moreover this shape allows the handle to stand on a surface with the blade and any lubrapad of an attached blade unit suspended above the surface. This can help prevent blade corrosion and adhesion of the lubrapad to the surface.

In one embodiment, the handle comprises a moulded translucent or transparent body of elastomeric material such as silicone, or TPE or rubber, for example having a Shore A hardness of 10 to 50.

As used herein, TPEs are thermoplastic elastomers, for example thermoplastic elastomers selected from the group of styrenic block copolymers (TPE-s; e.g. Thermoplast K, Thermolast M, Sofprene, or Laprene), thermoplastic olefins (TPE-o; e.g. For-Tec E), elastomeric alloys (TPE-v or TPV; e.g. Thermolast A, Thermolast V, Hipex, Forprene, Termotan-V, or Vegaprene), thermoplastic polyurethanes (TPU; e.g. Copec), thermoplastic copolyesters (TPE-E), thermoplastic polyamides and mixtures thereof.

As used herein, silicones (or polysiloxanes) are polymers that include any inert, synthetic compound made up of repeating units of siloxane.

These materials give a superior tactile feeling with a material that is soft and yet strong due to the bulbous shape of the handle. Moreover, the body being translucent or transparent allows the user to gain a better feel of the positioning of the handle (and thus of the attached blade unit) with respect to the hand and to the skin to be shaved.

In one embodiment, the front surface portion is flat or concave. This front surface may extend to the guard side of the attachment to the blade unit, and may conveniently be provided with a logo and/or instructions. It may extend substantially parallel to the rear surface portion and preferably substantially parallel to a main direction (in terms of longest extent) of the attachment means.

In one embodiment the front and/or rear surface portions extend at a slant to the continuous smooth surface (i.e. at a non-perpendicular angle). The top surface portion (and underneath surface portion) of the handle may be approximately parallel to the shaving plane in use. In this case, the front and/or rear surface portions extend at a slant to the user's skin. The slant may be back away from the cap, giving improved visibility.

In one embodiment the attachment means is a recess accommodating a stem of a blade unit. The recess may be of rectangular section, with a direction up into the handle, and in one embodiment at the same slant as the front and/or rear surfaces.

The body may have any suitable construction. In one embodiment the body is solid or contains a hard core or hard hollow core. This may allow the use of a softer material for the body.

In another embodiment the body is hollow and contains a shaving preparation, which, for example, can be squeezed out by the user via the attachment means to the blade unit. Thus the shaving preparation (which may contain lubricating and/or hair conditioner and/or moisturiser) may pass through the recess, for example within a part of the blade unit which is housed inside the recess.

Further embodiments relate to a safety razor (or safety razor system with a detachable blade unit) comprising a handle according to any of the definitions above, and a blade unit.

In one razor embodiment, the attachment means for attachment to the blade unit and corresponding means on the blade unit allow relative movement, such as pivoting movement, between the handle and the blade unit. For example the connection between the corresponding means and attachment means may have some play, or one or both of the attachment means or corresponding means may be flexible.

In one embodiment the corresponding means is a stem extending from the blade unit to the handle. The stem may fit into the recess, permanently or detachably.

In a further embodiment, the razor comprises a hard shell extending from the stem and forming part of the handle. The hard shell may give additional support to the body and a enable an enhanced connection to the blade unit.

In one embodiment either the stem or the shell is provided with a spigot (outlet for fluid connection from the body) which extends into the handle, to transport shaving preparation.

In one embodiment the shell forms the rear surface portion and part of the underneath and side surface portions of the handle. In this case, the shell may fit over the elastomeric material (such as TPE, rubber or silicone) body described previously. It may fit into receded surface portions of the body, so that the combination of the shell and the body provides a smooth external surface.

In one embodiment the safety razor further comprises a lubrapad. For example, a lubrapad body may be provided adjacent to the blade unit, and extend along a guard of the blade unit and in front of the guard in use. The lubrapad body may have a greatest width and/or depth in the blade direction at the guard, the body width and/or depth reducing in a smooth convex curve away from the guard to a curved front portion of the body.

In one embodiment the lubrapad body and blade unit are provided separately and comprise attachment means to attach them together whilst allowing relative movement, such as flexible projections from a front surface of the guard, which are to be housed in recesses in a surface portion of the lubrapad body which is directly facing the guard front surface.

In a further definition of the handle, invention embodiments provide a safety razor handle comprising a moulded translucent or transparent body of elastomeric material such as TPE, silicone or rubber having a Shore A hardness of 5 to 65 or preferably 10 to 50; wherein the body has a shape which is rounded and chunky (or bulbous), extending with perpendicular length l, width w and height h, wherein none of the maximum length, width and height of the body is more than 2, 3 or 4 times the size of the maximum in the other two dimensions.

For example, the height may be the largest vertical cross section thought the continuous smooth surface previously defined, the width may be the largest vertical cross section through the continuous smooth surface and the length may be the horizontal distance (parallel with the shaving place) between the front surface portion and the rear surface portion.

Any of the previous preferably features of the handle and safety razor (and safety razor system) may be applied to the further handle definition.

The above indicated aspects and embodiments may be combined with each other to achieve the advantageous effects as described above. Further embodiments, features, and advantages of the invention, as well as the structure and operation of the various embodiments of the invention are described in detail below with reference to the accompanying drawings.

### DESCRIPTION OF FIGURES

The accompanying drawings, which are incorporated herein and form a part of the specification, illustrate the present invention and, together with the description, further serve to explain the principles of the invention and to enable a person skilled in the pertinent art to make and use the invention.

Reference will now be made to FIGS. 1 to 13, in which:

FIG. 1 is a perspective view of a handle and blade unit with lubrapad from the top side (user side);

FIG. 2 is a side view of the handle and blade unit with lubrapad shown in FIG. 1;

FIG. 3 is another perspective view of the blade unit and lubrapad shown in FIG. 1, but from the front (user side);

FIG. 4 is another perspective view of the handle and blade unit with lubrapad shown in FIG. 1, but from underneath (skin side);

FIG. 5 is front view of the handle and blade unit with lubrapad shown in FIG. 1;

FIG. 6 is a rear view of the handle and blade unit with lubrapad shown in FIG. 1;

FIG. 7 is a perspective view of view of a handle and blade unit with lubrapad demonstrating the translucent material of the handle;

FIG. 8 is a view of a blade unit and lubrapad from underneath, in a disassembled state;

FIG. 9 is a perspective view of a safety razor including a hard shell of the handle, from the front/top side;

FIG. 10 is a side section view of a handle including a hard shell and a blade unit;

FIG. 11 is a perspective view from two angles of a disassembled safety razor system including a handle made up of a disassembled hard shell and body;

FIG. 12 is a perspective view of a safety razor in use under the arm; and

FIG. 13 is a perspective view of a safety razor in use on the shin.

### DETAILED DESCRIPTION OF EMBODIMENTS

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention.

The term “underneath” is used to describe features of the blade unit or lubrapad that are positioned on the skin-contacting side of the blade unit or lubrapad (i.e., on a shaving-side or underneath of the blade unit or lubrapad), and the term “top” is used to describe features of the blade unit or lubrapad that are positioned on a side opposite the skin-contacting side of the blade unit or lubrapad (i.e., on a user side or on top of the blade unit or lubrapad). The terms “front”, “rear”, and “side(s)” are used herein with reference to the shaving direction, i.e., the direction in which the blade unit and lubrapad are intended to be moved during shaving. In particular, the term “front” means facing the shaving direction, “rear” means facing away to the shaving direction, and “side(s)” mean to either side in the shaving direction.

The term substantially cylindrical or substantially ellipsoid or substantially partially spherical surface is used to describe a shape which is close to cylindrical or ellipsoid or partially spherical form, for example with a 10% deviation from one of those forms. In one measure, a section (or all sections) taken vertically through the continuous smooth surface (for example in a direction parallel to the blade length) overlaps with a circle or ellipse drawn to just cover the whole section with the areas of the circle or ellipse which are not covered by the section being up to one tenth of the area of the section.

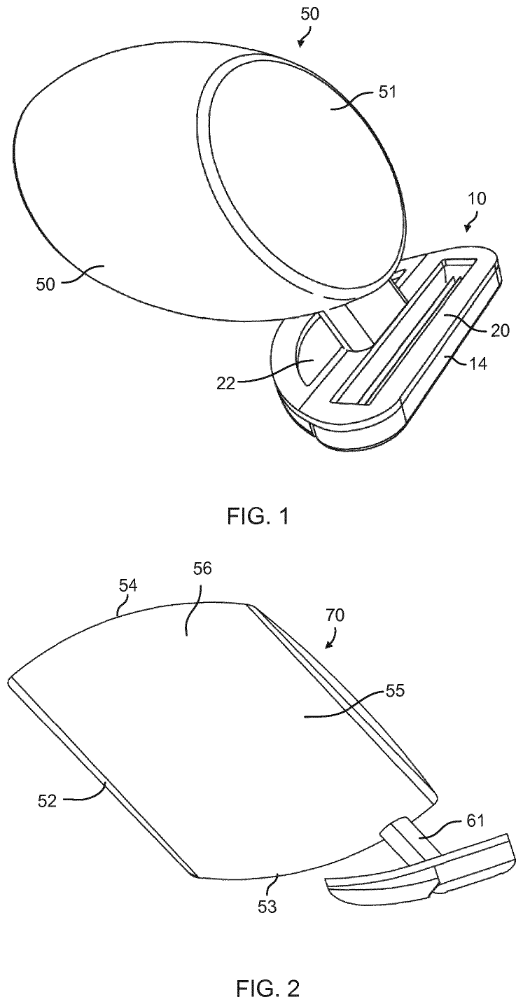

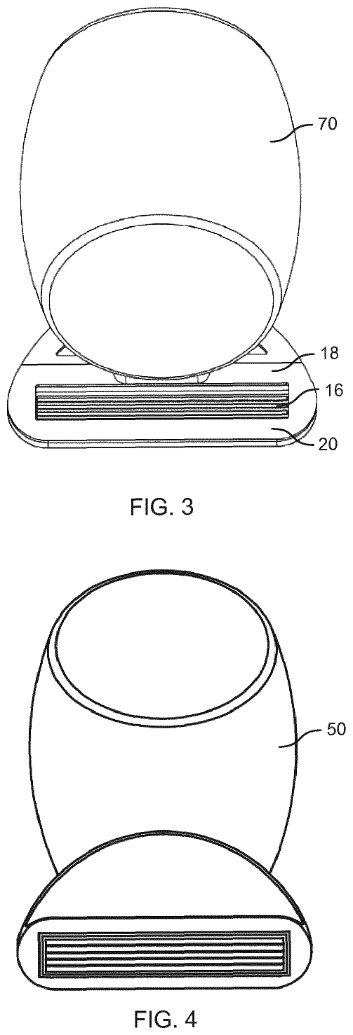

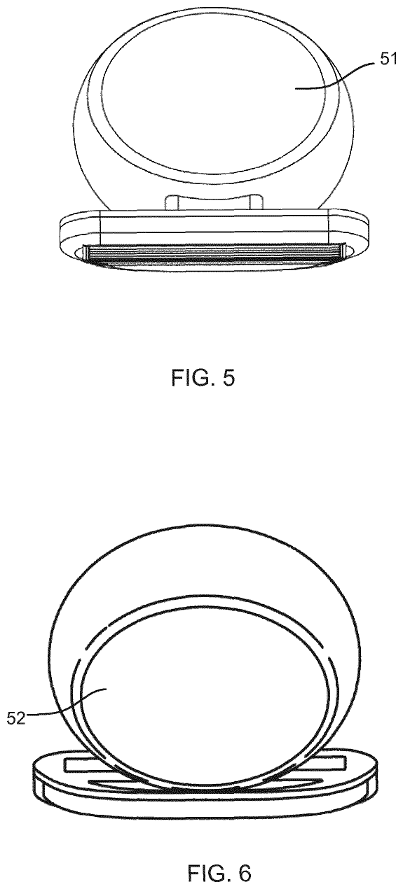

Reference will now be made to FIGS. 1 to 13, which are views of a blade unit 10 and handle 50, with an optional lubrapad body 22, according to embodiments. Generally speaking, the described embodiments can be differentiated from one another in terms of whether a hard shell 80 is provided and different lubrapad constructions, and also by how the blade unit 10 and lubrapad 12 are attached to each other and/or the handle 50, which can be of different constructions.

FIGS. 1 to 6 show different views of a handle 50 of rounded, chunky design attached to a blade unit 10 and lubrapad body 12 provided integrally with the blade unit and in front of the blade unit in the shaving direction.

The handle has a front surface portion 51, which is flat, a rear surface portion 52 which is also flat, a curved underneath surface portion 53 with attachment means 59 (not shown) into the handle, a curved top surface portion 54 and curved side surface portions 55. These curved surface portions together form a continuous smooth curved surface which is circular or spherical in cross section, but may vary in shape and size along its length between the front and rear of the handle. The handle may be seen as a barrel-shape, for example, with slanted ends, or a similar ellipsoid barrel shape.

The blade unit 10 includes a guard 18, a cap 20, and rounded portions 42 that together define a blade housing 14 within which a plurality of blades 16 are disposed. The number of blades 16 can be, for example, four or five, though it can be fewer or more than this. The guard 18 is in front of the blades 16 and the cap 20 is to the rear of the blades 16. The blade unit 10 can be connected to the handle 50, either fixedly or detachably.

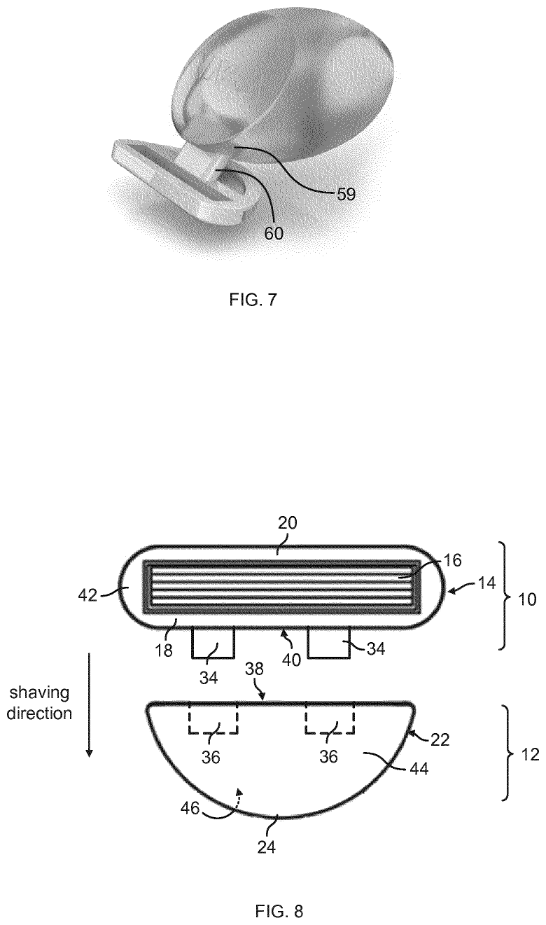

The handle is made entirely from a translucent silicone in this embodiment, as can be seen better in FIG. 7, which also reveals a recess acting as an attachment means 59 to the handle and the extension of a blade unit stem 61 into the body. The stem may have a friction fit with the body or the two parts may be otherwise detachably or fixedly connected together. The stem may include a fluid passage for a shaving preparation dispensed from within the body and the body may include a dispensing aperture. Alternatively, the body may be solid, have a hard core or have a hollow hard core. In any case, the material of the body is a soft or medium soft silicone or silicone equivalent of Shore hardness A between 10 and 50, which thus gives a pleasurable tactile sensation when gripped by the user. The translucent material is not only attractive but also practical in allowing parts behind the body to be glimpsed through the body and thus aiding user orientation and shaving performance.

The blade unit of these figures includes a lubrapad 12 as an integral part of the blade unit, with a single frame both surrounding the blades and providing a back support for the lubrapad.

FIG. 8 shows a different lubrapad and blade unit which may be used with the handle of embodiments. The lubrapad 12 comprises a lubrapad body 22 comprising solid lubricating material. The lubrapad body 22 has a first surface portion 38 which directly faces a front surface 40 of the guard 18, a second (bottom, gliding or skin-contacting) surface portion 44 adjacent to the skin-contacting side of the blade unit 10, and a third (top) surface portion 46 generally opposite the second surface portion 44. In use, the second surface portion 44 lubricates the skin of a user and the third surface portion 46 is directed away from the skin of the user towards the handle 50. The first, second and third surface portions 38, 44, 46 of the lubrapad body 22 generally define a wedge having a curved front portion (semi-circular or partially semi-circular edge) 24 with the second surface portion 44 curving towards the curved front portion 24. The second surface portion 44 can be continuously curved toward the front portion 24 or can include a flat portion before curving towards the front portion 24. The greatest length of the third surface portion 46 in the shaving direction can be at least twice or three or four times the height of the first surface portion 38 in a direction perpendicular to the shaving plane.

FIG. 8 shows the blade unit 10 and the lubrapad 12 from underneath and separated from one another for greater clarity. As shown, the blade unit 10 has projections 34 extending from a front surface 40 of the guard 18. (The reader should recall that “front” means facing the shaving direction.) When the blade housing 10 and the lubrapad 12 are joined together, the projections 34 are (at least partly) housed in recesses 36 in a surface portion 38 of the lubrapad 22 which is directly facing the front surface 40 of the guard 18. For simplicity, the projections 34 and recess 36 are shown as rectangular in shape. These can be friction fit, threaded, glued, overmolded, or otherwise secured together. Other types of projections, for example spikes, hooks or any other suitable shapes, can be provided alternatively.

The smooth/continuous reduction of the width and depth of this lubrapad and the convex form of the gliding surface allows improved gliding across the skin of a user, with provision of the most lubrication closest to the blades.

Separating the blade unit and lubrapad, so that they can move independently from one another, allows the cutting and lubricating functions to be separated, and that allows optimization of the blade unit and lubrapad design to conform to, or follow, the contours of a user's skin. The term ‘lubrapad’ generally refers to a solid shaving aid that has lubricating properties. The lubrapad can, of course, have other properties considered beneficial during shaving such as, for example, moisturizing properties. The lubrapad can be provided ‘bare’ in that it is not contained or surrounded by any manner of housing, base, or holder. Furthermore, the lubrapad body can consist entirely of solid lubricating material or the lubricating material can form part of the body, such as a layer on the body.

The composition of the lubrapads described herein can include a gliding agent. Materials which may be selected as the gliding agent are: PEG-400/1,4-Butanediol/SMDI Copolymer, PEG-115M, PEG 45M, and PEG-5M, or a combination thereof. The composition of the lubrapad can include an antioxidant agent, for example Tocopherol. The composition of the lubrapad can include an anti-inflammatory agent, for example aloe barbadensis leaf juice. The composition of the lubrapad can include a backbone structure. Materials which may be selected as the backbone structure are: styrenic block copolymers and polystyrene, or a combination thereof.

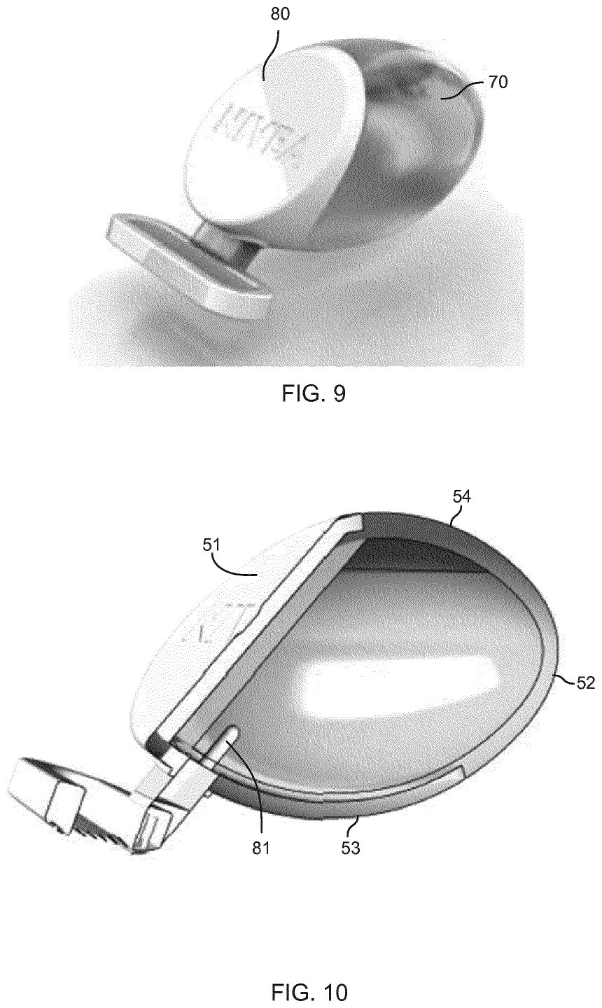

FIGS. 9 to 11 show another safety razor 60 which generally has the same construction as that shown in FIGS. 1 to 9 (with like reference numbers denoting like features), except that here there is an additional hard shell and no lubrapad (of course a lubrapad according to either of the previous descriptions or any other lubrapad could be added).

The handle 50 includes a hard curved shell 80 and the soft/medium soft silicone body 70. The hard shell is provided at the front of the razor (closest to the cap) and forms the slanted front surface portion. It also curves to form part of the underneath surface portion. Where it joins the soft body, the body is shaped with receded portions 82 to give a smooth continuous external curved surface.

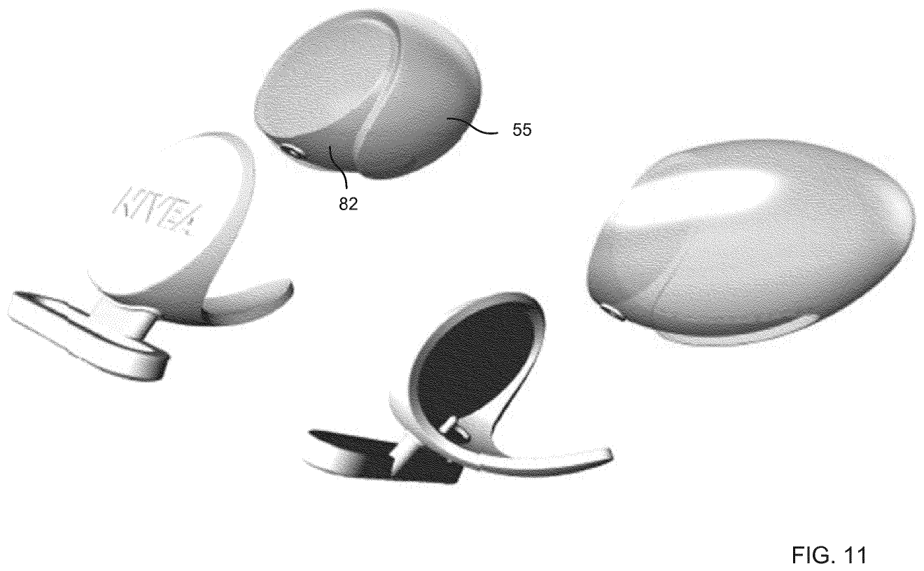

The shell is formed integrally with the stem 61 of the blade unit and the blade unit, but is detachable from the body 70. FIGS. 10 and 11 show the spigot 81 allowing flow of shaving preparation from the hollow body and the dispensing aperture 83.

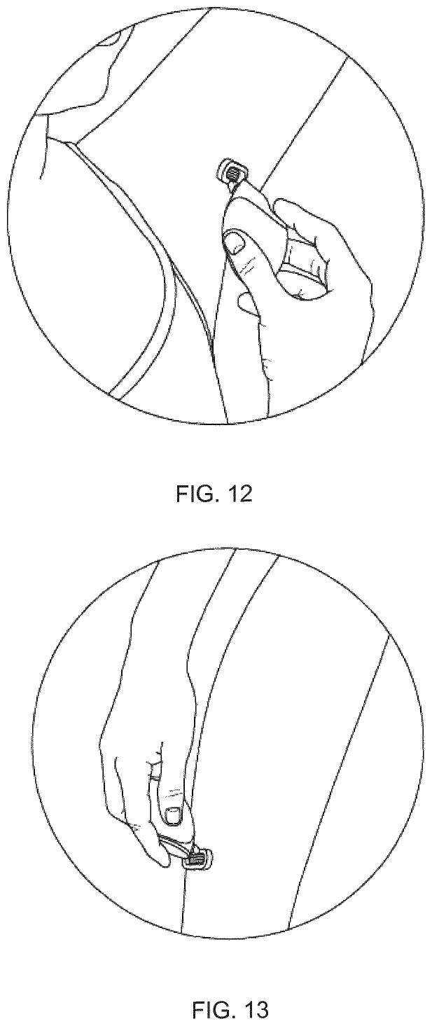

FIGS. 12 and 13 show a razor including a hard shell in use, demonstrating how its chunky form fits well into the human hand, with possible positioning of the forefinger on the hard shell.

The Summary and Abstract sections may set forth one or more but not all exemplary embodiments of the present invention as contemplated by the inventor(s), and thus, are not intended to limit the present invention and the appended claims in any way.

The breadth and scope of the present invention should not be limited by any of the above-described exemplary embodiments, but should be defined only in accordance with the following claims and their equivalents.

### REFERENCE NUMBERS

10 blade unit

12 lubrapad

14 blade housing

16 blades

18 guard

20 cap

22 lubrapad body

24 front portion (of the lubrapad body)

34 projections

36 recesses

38 first surface portion (of the lubrapad body)

40 front surface (of the guard)

42 rounded portions (of the blade unit)

44 second surface portion (of the lubrapad body)

46 third surface portion (of the lubrapad body)

50 handle

51 front surface portion

52 rear surface portion

53 underneath surface portion

54 top surface portion

55 side surface portion

56 continuous smooth surface

57 post

58 top plate

59 attachment means

60 corresponding means (corresponding to attachment means of handle)

61 blade unit stem

70 moulded body

80 hard shell

81 spigot

82 receded portions of body

83 dispensing aperture

100 safety razor system

1.-17. (canceled)

18. A safety razor handle, wherein the handle comprises:
an underneath surface portion facing skin of a user in use and comprising an attachment element for attachment to a blade unit;
a front surface portion facing in an opposite direction from a shaving direction in use;
a rear surface portion facing in the shaving direction in use;
a top surface portion and side surface portions, one directed to either side of a blade length in use;
the top surface portion, the underneath surface portion and the side surface portions together forming a continuous smooth surface which is a substantially cylindrical or substantially ellipsoid or substantially partially spherical surface; and wherein a distance between the front surface portion and the rear surface portion is between one third and three times a largest dimension of a largest cross section through the continuous smooth surface.

19. The handle of claim 18, wherein the front surface portion and the rear surface portion is between a half and twice the largest dimension of the largest cross section through the continuous smooth surface.

20. The handle of claim 18, wherein the handle further comprises a molded translucent or transparent body of elastomeric material having a Shore A hardness of 5 to 65.

21. The handle of claim 20, wherein the elastomeric material has a Shore A hardness of 10 to 50.

22. The handle of claim 18, wherein the front surface portion is flat or concave and extends substantially parallel to the rear surface portion.

23. The handle of claim 22, wherein the front surface portion extends substantially parallel to a direction of the attachment element.

24. The handle of claim 18, wherein the front and/or rear surface portions extend at a slant to the continuous smooth surface.

25. The handle of claim 18, wherein the attachment element is a recess accommodating a stem of a blade unit.

26. The handle of claim 25, wherein a body of the handle is solid or contains a hard core or hard hollow core.

27. The handle of claim 25, wherein a body of the handle is hollow and contains a shaving preparation, which can be squeezed out by the user via the attachment element to the blade unit.

28. A safety razor, wherein the razor comprises the handle of claim 18.

29. The razor of claim 28, wherein the attachment element for attachment to the blade unit and a corresponding element on the blade unit allow relative movement between the handle and the blade unit.

30. The razor of claim 28, wherein the razor further comprises a stem which extends from the blade unit to the handle.

31. The razor of claim 30, wherein the razor further comprises a hard shell extending from the stem and forming part of the handle.

32. The razor of claim 31, wherein the stem or shell is provided with a spigot which extends into the handle, to transport shaving preparation.

33. The razor of claim 31, wherein the shell forms the rear surface portion and part of the underneath and side surface portions of the handle.

34. The razor of claim 33, wherein the shell fits over an elastomeric material body into receded surface portions of the body, so that the combination of the shell and the body provides a smooth surface.

35. The razor of claim 33, wherein the razor further comprises a lubrapad body which is provided adjacent to the blade unit and extends along a guard of the blade unit and in front of the guard in use, the lubrapad body having a greatest width and/or depth in a blade direction at the guard, a body width and/or depth reducing in a smooth convex curve away from the guard to a curved front portion of the body.

36. The razor of claim 35, wherein the lubrapad body and blade unit are provided separately and comprise attachment elements to attach them together whilst allowing relative movement.

37. A safety razor handle, wherein the handle comprises a molded translucent or transparent body of silicone having a Shore A hardness 5 to 65; the body having a shape which is rounded and chunky, extending with perpendicular length l, width w and height h, wherein none of a maximum length, a maximum width and a maximum height of the body is more than 4 times a size of a maximum in the other two dimensions.
